(19) United States
(12) Patent Application Publication
(10) Pub. No.: US 2015/0178574 A1
(43) Pub. Date: Jun. 25, 2015

(54) BRIGHTNESS VALUE CALCULATION APPARATUS AND LANE MARKING DETECTION SYSTEM

(71) Applicant: DENSO CORPORATION, Kariya-city (JP)

(72) Inventors: Shunsuke SUZUKI, Aichi-ken (JP); Syunya KUMANO, Gothenburg (SE); Naoki KAWASAKI, Kariya-shi (JP); Tetsuya TAKAFUJI, Anjo-shi (JP)

(21) Appl. No.: 14/576,863

(22) Filed: Dec. 19, 2014

(30) Foreign Application Priority Data
Dec. 24, 2013 (JP) 2013-265454

(51) Int. Cl. G06K 9/00; G06T 7/40

(52) U.S. Cl. CPC G06K 9/00798; G06T 7/408; G06T 2207/10024; G06T 2207/30256

(57) ABSTRACT

A brightness value calculation apparatus includes a color image obtaining section which obtains a color image obtained by imaging a view outside a vehicle and a brightness value calculation section which calculates a brightness value A of a pixel of at least part of the color image based on an expression (1):

A=αA_{R}+βA_{G}+γA_{B} (1)

where A_{R} is brightness of R (red) of the pixel for which the brightness value A is to be calculated, A_{G} is brightness of G (green) of the pixel for which the brightness value A is to be calculated, A_{B} is brightness of B (blue) of the pixel for which a brightness value A is to be calculated, and α, β, γ are constants satisfying a relationship α>β>γ.

### CROSS-REFERENCE TO RELATED APPLICATION

This application is based on and claims the benefit of priority from earlier Japanese Patent Application No. 2013-265454 filed Dec. 24, 2013, the description of which is incorporated herein by reference.

### BACKGROUND

1. Technical Field

The present invention relates to a brightness value calculation apparatus and a lane marking detection system.

2. Related Art

A lane marking detection apparatus is known which processes a color image of a road surface ahead of a vehicle to detect a lane marking. This lane marking detection apparatus extracts edge points, which are points where a brightness value changes, from the color image to detect the lane marking on the basis of the extracted edge points.

The lane marking detected by the lane marking detection apparatus can be combined with behavioral information such as a traveling direction, a speed, and a steering angle of the vehicle, so as to be used for a prediction whether or not the vehicle deviates from the lane, or for automatic steering angle control.

Meanwhile, depending on a color of a lane marking, the difference between brightness values (contrast) of the lane marking and a road surface outside the lane marking is smaller, which may not precisely extract edge points.

To solve the problem, an in-vehicle image processing camera apparatus is proposed (see JP-A-2003-32669). The in-vehicle image processing camera apparatus obtains a color image of a road surface as three individual color signals, and selects a combination of the color signals in which the difference between brightness values of a lane marking and the road surface excluding the lane marking is maximized to perform recognition processing of the lane marking by using the selected combination of the color signals.

However, according to the technique described in JP-A-2003-32669, depending on a certain color of a lane marking, the difference between the brightness values of the lane marking and the road surface excluding the lane marking is not sufficiently larger. Hence, the lane marking cannot be precisely detected.

### SUMMARY

An embodiment provides a brightness value calculation apparatus and a lane marking detection system which can make larger the difference between brightness values of a lane marking and a road surface excluding the lane marking.

As an aspect of the embodiment, a brightness value calculation apparatus is provided which includes: a color image obtaining section which obtains a color image obtained by imaging a view outside a vehicle; and a brightness value calculation section which calculates a brightness value A of a pixel of at least part of the color image based on an expression (1):

A=αA_{R}+βA_{G}+γA_{B} (1)

where A_{R} is brightness of R (red) of the pixel for which the brightness value A is to be calculated, A_{G} is brightness of G (green) of the pixel for which the brightness value A is to be calculated, A_{B} is brightness of B (blue) of the pixel for which a brightness value A is to be calculated, and α, β, γ are constants satisfying a relationship α>β>γ.

### BRIEF DESCRIPTION OF THE DRAWINGS

In the accompanying drawings:

FIG. 1 is a block diagram showing a configuration of an image sensor;

FIG. 2 is a flowchart showing a process performed by the image sensor according to a first embodiment; and

FIG. 3 is a flowchart showing a process performed by the image sensor according to a second embodiment.

### DETAILED DESCRIPTION OF THE PREFERRED EMBODIMENTS

With reference to the accompanying drawings, hereinafter are described embodiments of the present invention.

### First Embodiment

1. Configuration of an Image Sensor 1

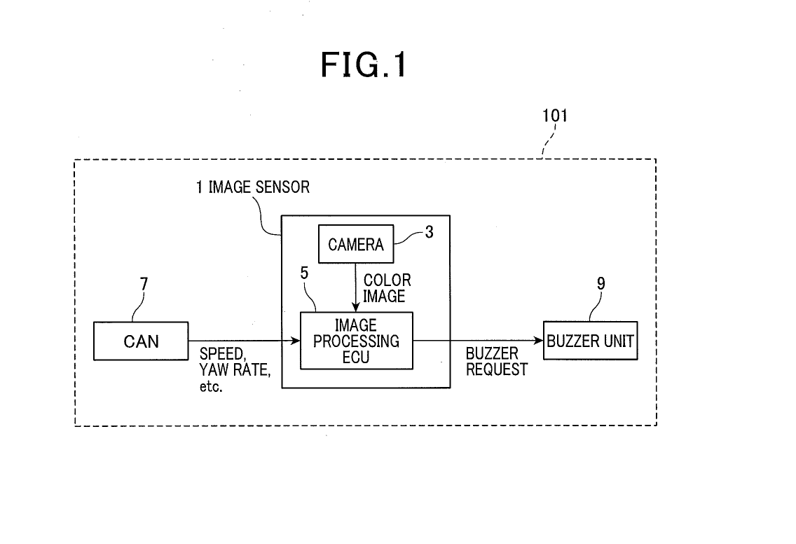

The configuration of the image sensor (lane marking detection to system, brightness value calculation apparatus) 1 is described with reference to FIG. 1. The image sensor 1 is an in-vehicle apparatus installed in a vehicle 101. The image sensor 1 includes a camera 3 and an image processing ECU (electronic control unit) (lane marking detection apparatus) 5. The camera 3 is placed outside a vehicle 101, in particular, at a position where the camera 3 can image views ahead of the vehicle 101.

The camera 3 generates a color image. An imaging area of this color image includes .a road ahead of the vehicle 101. In addition, each pixel of the color image has a brightness value (luminance value) of any one of R (red), B (blue), and G (green) according to a Bayer array. The camera 3 outputs the color image to the image processing ECU 5.

The image processing ECU (lane marking detection apparatus) 5 is a known computer. The image processing ECU 5 obtains information such as a speed and a yaw rate of the vehicle 101 from a

CAN 7. In addition, the image processing ECU 5 obtains a color image from the camera 3 as described above. The image processing ECU 5 performs a process described later by using the obtained color image and information such as the speed and the yaw rate.

In the process described later, if the image processing ECU 5 determines that the vehicle 101 deviates from a lane, that is, the vehicle 101 crosses (deviates across) a lane marking (lane marker, line), the image processing ECU 5 outputs a control signal for requesting sounding a buzzer to a buzzer unit 9 included in the vehicle 101. When the buzzer unit 9 receives the control signal, the buzzer unit 9 sounds the buzzer.

Note that the image processing ECU 5 is an embodiment of a color image obtaining means (section), a brightness value calculation means (section), a brightness value calculation apparatus, a yellow area determination means (section), and a lane marking detection system.

2. Process Performed by the Image Sensor 1

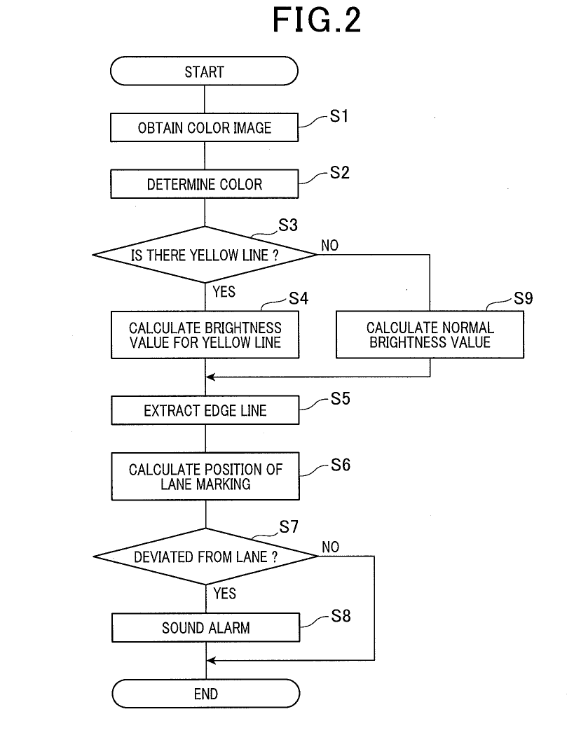

The process repeatedly performed at a predetermined period by the image sensor 1 (especially, the image processing ECU 5) is described with reference to FIG. 2. In step S1, the image processing ECU 5 obtains a color image from the camera 3. The color image is obtained by imaging a view ahead of the vehicle 101.

In step S2, the image processing ECU 5 determines a color as described below. First, the image processing ECU 5 calculates a determination value X expressed by the expression (5) for each pixel of the color image obtained in the step 1:

X=A_{R}−A_{B} (5)

where A_{R} is a brightness value of R (red) of the pixel for which a determination value X is to be calculated and which is calculated by a known interpolation method, and A_{B} is a brightness value of B (blue) of the pixel for which a determination value X is to be calculated and which is calculated by the known interpolation method. The interpolation method can be appropriately selected from various interpolation methods (e.g. linear interpolation method, gradient method, ACPI method and the like) used for reproducing colors of pixels from the color image of the Bayer array.

Next, for each of the pixels of the color image, the image processing ECU 5 determines whether or not the determination value X is larger than a predetermined threshold value (first threshold value). The determination value X is larger if the color of the pixel calculated by interpolation is yellow, and is smaller if the color of the pixel is other than yellow.

In step S3, the image processing ECU 5 determines whether or not there is a yellow line (a lane marking whose color is yellow) in the color image obtained in the step 1 on the basis of the determination result of the step 2. That is, in the step S2, if there is at least one pixel whose determination value X is determined to be larger than the threshold value (first threshold value), the image processing ECU 5 determines that there is a yellow line, and the process proceeds to step 4. Conversely, if there is no pixel whose determination value X is determined to be larger than the threshold value (first threshold value), the image processing ECU 5 determines that there is no yellow line, and the process proceeds to step 9.

In step S4, for each of the pixels of the color image, the image processing ECU 5 calculates a brightness value A on the basis of the following expression (6):

A=A₀+A_{R}−A_{B} (6)

where A₀ is a brightness value of the pixel for which the brightness value A is to be calculated and which is subject to gray-scale processing. A₀ can be expressed by the following expression (7):

A₀=(A_{R}+A_{G}+A_{B})/3 (7)

where A_{R} and A_{B} are described above, and A_{G} is a brightness value of G (green) of the pixel for which the brightness value A is to be calculated and which is calculated by a known interpolation method. The interpolation method can be appropriately selected from various interpolation methods (e.g. linear interpolation method, gradient method, ACPI method and the like) used for reproducing colors of pixels from the color image of the Bayer array.

Hence, when substituting the expression (7) for the expression (6), the brightness value A is expressed by the following expression (8):

A=(4/3)×A_{R}+(1/3)×A_{G}−(2/3)×A_{B} (8)

In step S5, first, the image processing ECU 5 generates a brightness value image in which each of the pixels has the brightness value A calculated in the step S4 or step S9 described later. The image processing ECU 5 sets a plurality of lines extending in the direction orthogonal to the travelling direction of the vehicle in the brightness value image. The spacings between the lines on the brightness value image are set so that actual distances thereof become equal to each other. That is, assuming that the lines are on a road surface, the spacings between the lines are set so as to be equal to each other on the road surface.

Next, the image processing ECU 5 provides differential filter processing for brightness values on the line to extract points, at which differential values of the brightness values become the local maximum or the local minimum, as edge points. Of the edge points, the edge points successive in the longitudinal direction are determined that they do not form a lane marking, and are removed.

Finally, the image processing ECU 5 provides Hough transform for the extracted edge points to extract a line passing through the most edge points as an edge line.

In step 6, the image processing ECU 5 calculates the position of the lane marking on the basis of the edge line extracted in the immediately preceding step 5 and the edge line obtained from a predetermined number of past color images. Note that the plurality of edge lines detected at a plurality of times are used for increasing the accuracy in detecting a lane marking. Then, the image processing ECU 5 calculates the distance between the vehicle and the lane marking on the basis of the calculated position of the lane marking.

In step S7, the image processing ECU 5 determines deviation from the lane. First, the image processing ECU 5 predicts a traveling path of the vehicle on the basis of a yaw rate and a speed obtained from the CAN 7. Next, the image processing ECU 5 calculates a period of time passing until the vehicle deviates from a lane, that is, the vehicle crosses (deviates across) a lane marking (lane marker, line), on the basis of the position of the lane marking calculated in the step 6, the distance from the vehicle to the lane marking, and the predicted traveling path.

If the calculated period of time passing until the vehicle deviates from the lane is less than a predetermined threshold value (second threshold value) (e.g. one second), the image processing ECU 5 determines that the vehicle may deviate from the lane, that is, the vehicle may cross (deviate across) the lane marking (lane marker, line). Then, the process proceeds to step S8. Conversely, if the calculated period of time passing until the vehicle deviates from the lane is not less than the predetermined threshold value (second threshold value), the image processing ECU 5 determines that the vehicle may not deviate from the lane. Then, the process is completed.

In step S8, the image processing ECU 5 outputs a control signal for requesting sounding a buzzer to the buzzer unit 9. The buzzer unit 9 sounds the buzzer in response to the control signal.

If negative determination is made in the step S3, the process proceeds to step S9. In step S9, for each of the pixels of the color image, the image processing ECU 5 calculates a brightness value A on the basis of the following expression (9):

A=A₀ (9)

where A₀ is expressed by the expression (7) as described above. After the step S9, the process proceeds to the step S5.

3. Advantages Provided by the Image Sensor 1

(1) If there is a yellow line on the road, the image sensor 1 calculates the brightness value A expressed by the expressions (6) and (8) and detects a lane marking on the basis of the brightness value A. The difference is larger between the brightness value A of a yellow line and that of an area other than the yellow line. Hence, the image sensor 1 can precisely detect the yellow line.

(2) If there is no yellow line on the road, the image sensor 1 calculates the brightness value A expressed by the expression (9), and detects a lane marking on the basis of the brightness value A. The difference is larger between the brightness value A of a lane marking in color other than yellow (e.g. white) and that of an area other than the lane marking. Hence, the image sensor 1 can also precisely detect the lane marking in color other than yellow.

4. Modifications

(1) The color image generated by the camera 3 may be a color image of other than the Bayer array. For example, pixels of C (Clear), in addition to R, G, B, may be included. In addition, each pixel of the color image may have brightness values of R, G, and B.

(2) The brightness value A is not limited to a value expressed by the expression (8), but can be generally expressed by the following expression (1):

A=αA_{R}+βA_{G}+γA_{B} (1)

where α, β, γ are constants satisfying the relationship α>β>γ; β, γ may be a positive value, a negative value, or zero; and α may be, for example, a positive value.

The difference is larger between the brightness value A expressed by the expression (1) of a yellow line and that of an area other than the yellow line. Hence, the yellow line can be precisely detected by using the brightness value A expressed by the expression (1).

(3) The brightness value A is not limited to a value expressed by the expression (6), but can be generally expressed by the following expression (2):

A=A₀+pA_{R}−qA_{B} (2)

where p, q are positive constant values.

The difference is larger between the brightness value A, which is expressed by the expression (2), of a yellow line and that of an area other than the yellow line. Hence, the yellow line can be precisely detected by using the brightness value A expressed by the expression (2).

(4) After the step S1, the image sensor 1 may not perform the processes in the steps S2 and S3, but may directly proceed to the step 4. That is, the image sensor 1 may always calculate the brightness value A on the basis of the expression (8).

(5) In the step S3, the determination may be made as described below. That is, in the color image, if an area consisting of pixels having the determination value X, which is larger than the threshold value (first threshold value), is equal to or larger than a predetermined threshold value (third threshold value) (e.g. an area consisting of a plurality of pixels), the process can proceed to step S4. In another case, the process can proceed to step S9. Hence, it can be prevented from detecting the presence of a yellow line from noise generated from a small number of pixels.

(6) The determination value X is not limited to a value expressed by the expression (5), but can be generally expressed by the following expression (10):

X=pAR−qAB (10)

where p, q are positive constant values.

The difference is larger between the determination value X, which is expressed by the expression (10), of a yellow line and that of an area other than the yellow line. Hence, the yellow line and the area other than the yellow line can be precisely determined by using the determination value X expressed by the expression (10).

(7) The processes in the steps 2, 4 and 9 may be performed for all the pixels of the color image, or may be selectively performed for part of areas (e.g. an area in which the probability is higher that there is a lane marking).

(8) The image sensor 1 may not include the camera 3. In this case, the image sensor 1 can obtain a color image from an in-vehicle camera provided in addition to the image sensor 1.

### Second Embodiment

1. Configuration of the Image Sensor 1

The image sensor 1 has a configuration shown in FIG. 1 as in the case of the first embodiment. Note that the image processing ECU 5 is an embodiment of a color image obtaining means (section), a brightness value calculation means (section), a brightness value calculation apparatus, a blue area determination means (section), and a lane marking detection system.

2. Process Performed by the Image Sensor 1

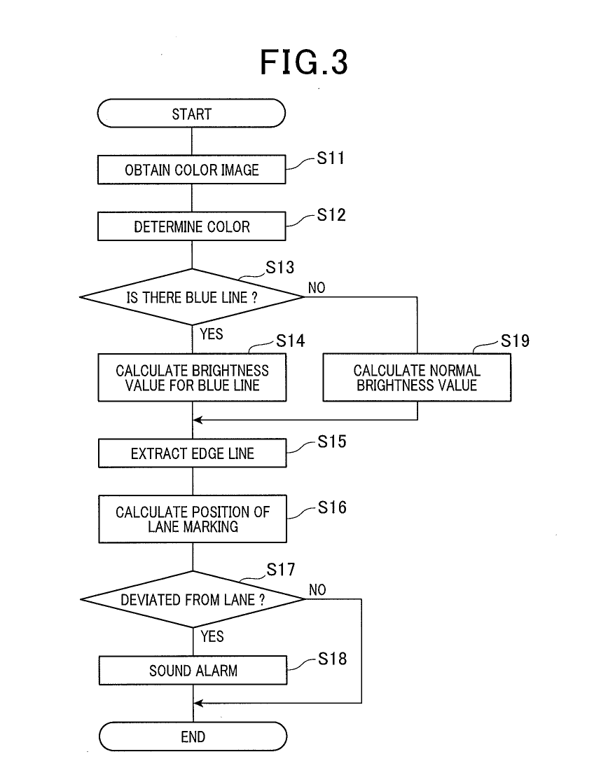

The process repeatedly performed at a predetermined period by the image sensor 1 (especially, the image processing ECU 5) is described with reference to FIG. 3. In step S11, the image processing ECU 5 obtains a color image from the camera 3. The color image is obtained by imaging a view ahead of the vehicle 101.

In step S12, the image processing ECU 5 determines a color as described below. First, the image processing ECU 5 calculates a determination value X expressed by the expression (11) for each pixel of the color image obtained in the step 11:

X=−A_{R}+A_{B} (11)

where A_{R} is a brightness value of R (red) of the pixel for which a determination value X is to be calculated and which is calculated by a known interpolation method, and A_{B} is a brightness value of B (blue) of the pixel for which a determination value X is to be calculated and which is calculated by a known interpolation method. The interpolation method can be appropriately selected from various interpolation methods (e.g. linear interpolation method, gradient method, ACPI method and the like) used for reproducing colors of pixels from the color image of the Bayer array.

Next, for each of the pixels of the color image, the image processing ECU 5 determines whether or not the determination value X is larger than a predetermined threshold value (first threshold value). The determination value X is larger if the color of the pixel calculated by interpolation is blue, and is smaller if the color of the pixel is other than blue.

In step S13, the image processing ECU 5 determines whether or not there is a blue line (a lane marking whose color is blue) in the color image obtained in the step 11 on the basis of the determination result of the step 12. That is, in the step S12, if there is at least one pixel whose determination value X is determined to be larger than the threshold value (first threshold value), the image processing ECU 5 determines that there is a blue line, and the process proceeds to step 14. Conversely, if there is no pixel whose determination value X is determined to be larger than the threshold value (first threshold value), the image processing ECU 5 determines that there is no blue line, and the process proceeds to step 19.

In step S14, for each of the pixels of the color image, the image processing ECU 5 calculates a brightness value A on the basis of the following expression (12):

A=A₀−A_{R}+A_{B} (12)

where A₀ is a brightness value of the pixel for which the brightness value A is to be calculated and which is subject to gray-scale processing. A₀ can be expressed by the following expression (13):

A₀=(A_{R}+A_{G}+A_{B})/3 (13)

where A_{R} and A_{B} are described above, and A_{G} is a brightness value of G (green) of the pixel for which the brightness value A is to be calculated and which is calculated by a known interpolation method. The interpolation method can be appropriately selected from various interpolation methods (e.g. linear interpolation method, gradient method, ACPI method and the like) used for reproducing colors of pixels from the color image of the Bayer array.

Hence, when substituting the expression (13) for the expression (12), the brightness value A is expressed by the following expression (14):

A=−(2/3)×A_{R}+(1/3)×A_{G}+(4/3)×A_{B} (14)

In step S15, first, the image processing ECU 5 generates a brightness value image in which each of the pixels has the brightness value A calculated in the step S14 or step S19 described later. The image processing ECU 5 sets a plurality of lines extending in the direction orthogonal to the travelling direction of the vehicle in the brightness value image. The spacings between the lines on the brightness value image are set so that actual distances thereof become equal to each other. That is, assuming that the lines are on a road surface, the spacings between the lines are set so as to be equal to each other on the road surface.

Next, the image processing ECU 5 provides differential filter processing for brightness values on the line to extract points, at which differential values of the brightness values become the local maximum or the local minimum, as edge points. Of the edge points, the edge points successive in the longitudinal direction are determined that they do not form a lane marking, and are removed.

Finally, the image processing ECU 5 provides Hough transform for the extracted edge points to extract a line passing through the most edge points as an edge line.

In step 16, the image processing ECU 5 calculates the position of the lane marking on the basis of the edge line extracted in the immediately preceding step 15 and the edge line obtained from a predetermined number of past color images. Note that the plurality of edge lines detected at a plurality of times are used for increasing the accuracy in detecting a lane marking. Then, the image processing ECU 5 calculates the distance between the vehicle and the lane marking on the basis of the calculated position of the lane marking.

In step S17, the image processing ECU 5 determines deviation from the lane. First, the image processing ECU 5 predicts a traveling path of the vehicle on the basis of a yaw rate and a speed obtained from the CAN 7. Next, the image processing ECU 5 calculates a period of time passing until the vehicle deviates from the lane, that is, the vehicle crosses (deviates across) the lane marking (lane marker, line), on the basis of the position of the lane marking calculated in the step 16, the distance from the vehicle to the lane marking, and the predicted traveling path.

If the calculated period of time passing until the vehicle deviates from the lane is less than a predetermined threshold value (second threshold value) (e.g. one second), the image processing ECU 5 determines that the vehicle may deviate from the lane, that is, the vehicle crosses (deviates across) the lane marking (lane marker, line). Then, the process proceeds to step S18. Conversely, if the calculated period of time passing until the vehicle deviates from the lane is not less than a predetermined threshold value (second threshold value), the image processing ECU 5 determines that the vehicle may not deviate from the lane. Then, the process is completed.

In step S18, the image processing ECU 5 outputs a control signal for requesting sounding a buzzer to the buzzer unit 9. The buzzer unit 9 sounds the buzzer in response to the control signal.

If negative determination is made in the step S13, the process proceeds to step S19. In step S19, for each of the pixels of the color image, the image processing ECU 5 calculates a brightness value A on the basis of the following expression (15):

A=A₀ (15)

where A₀ is expressed by the expression (13) as described above. After the step S19, the process proceeds to the step S15.

3. Advantages Provided by the Image Sensor 1

(1) If there is a blue line on the road, the image sensor 1 calculates the brightness value A expressed by the expressions (12) and (14) and detects a lane marking on the basis of the brightness value A. The difference is larger between the brightness value A of a blue line and that of an area other than the blue line. Hence, the image sensor 1 can precisely detect the blue line.

(2) If there is no blue line on the road, the image sensor 1 calculates the brightness value A expressed by the expression (15), and detects a lane marking on the basis of the brightness value A. The difference is larger between the brightness value A of a lane marking in color other than blue (e.g. white) and that of an area other than the lane marking. Hence, the image sensor 1 can also precisely detect the lane marking in color other than blue.

4. Modifications

(1) The color image generated by the camera 3 may be a color image of other than the Bayer array. For example, pixels of C (Clear), in addition to R, G, B, may be included. In addition, each pixel of the color image may have brightness values of R, B, and G.

(2) The brightness value A is not limited to a value expressed by the expression (14), but can be generally expressed by the following expression (3):

A=δA_{R}+εA_{G}+3A_{B} (3)

where δ, ε, 3 are constants satisfying the relationship δ<ε<3; δ, ε may be a positive value, a negative value, or zero; and 3 may be, for example, a positive value.

The difference is larger between the brightness value A, which is expressed by the expression (3), of a blue line and that of an area other than the blue line. Hence, the blue line can be precisely detected by using the brightness value A expressed by the expression (3).

(3) The brightness value A is not limited to a value expressed by the expression (12), but can be generally expressed by the following expression (4):

A=A₀pA_{R}+qA_{B} (4)

where p, q are positive constant values.

The difference is larger between the brightness value A, which is expressed by the expression (4), of a blue line and that of an area other than the blue line. Hence, the blue line can be precisely detected by using the brightness value A expressed by the expression (4).

(4) After the step S11, the image sensor 1 may not perform the processes in the steps S12 and S13, but may directly proceed to the step 14. That is, the image sensor 1 may always calculate the brightness value A on the basis of the expression (14).

(5) In the step S13, the determination may be made as described below. That is, in the color image, if an area consisting of pixels having the determination value X, which is larger than the threshold value (first threshold value), is equal to or larger than a predetermined threshold value (third threshold value) (e.g. an area consisting of a plurality of pixels), the process can proceed to step S14. In another case, the process can proceed to step S19. Hence, it can be prevented from detecting the presence of a blue line from noise generated from a small number of pixels.

(6) The determination value X is not limited to a value expressed by the expression (11), but can be generally expressed by the following expression (16):

X=−pA_{R}+qA_{B} (16)

where p, q are positive constant values.

The difference is larger between the determination value X, which is expressed by the expression (16), of a blue line and that of an area other than the blue line. Hence, the blue line and the area other than the blue line can be precisely determined by using the determination value X expressed by the expression (16).

(7) The processes in the steps 12, 14 and 19 may be performed for all the pixels of the color image, or may be selectively performed for part of areas (e.g. an area in which the probability is higher that there is a lane marking).

(8) The image sensor 1 may not include the camera 3. In this case, the image sensor 1 can obtain a color image from an in-vehicle camera provided in addition to the image sensor 1.

It will be appreciated that the present invention is not limited to the configurations described above, but any and all modifications, variations or equivalents, which may occur to those who are skilled in the art, should be considered to fall within the scope of the present invention.

For example, parts or the whole of the configurations of the first and second embodiments may be appropriately combined.

Hereinafter, aspects of the above-described embodiments will be summarized.

As an aspect of the embodiment, a brightness value calculation apparatus (1) is provided which includes: a color image obtaining section (5) which obtains a color image obtained by imaging a view outside a vehicle; and a brightness value calculation section (5) which calculates a brightness value A of a pixel of at least part of the color image based on an expression (1):

A=αA_{R}+βA_{G}+γA_{B} (1)

where A_{R} is brightness of R (red) of the pixel for which the brightness value A is to be calculated, A_{G} is brightness of G (green) of the pixel for which the brightness value A is to be calculated, A_{B} is brightness of B (blue) of the pixel for which a brightness value A is to be calculated, and α, β, γ are constants satisfying a relationship α>β>γ.

The brightness value calculation apparatus calculates the brightness value A expressed by the expression (1). The difference is larger between the brightness value A, which is expressed by the expression (1), of a yellow line (yellow lane marking) and that of an area other than the yellow line. Hence, by using the brightness value A expressed by the expression (1), the yellow line can be precisely detected.

As another aspect of the embodiment, a brightness value calculation apparatus (1) is provided which includes: a color image obtaining section (5) which obtains a color image obtained by imaging a view outside a vehicle; and a brightness value calculation section (5) which calculates a brightness value A of a pixel of at least part of the color image based on an expression (3):

A=δA_{R}+εA_{G}+3A_{B} (3)

where A_{R} is brightness of R (red) of the pixel for which the brightness value A is to be calculated, A_{G} is brightness of G (green) of the pixel for which the brightness value A is to be calculated, A_{B} is brightness of B (blue) of the pixel for which a brightness value A is to be calculated, and δ, ε, 3 are constants satisfying a relationship δ<ε<3.

The brightness value calculation apparatus calculates the brightness value A expressed by the expression (3). The difference is larger between the brightness value A, which is expressed by the expression (3), of a blue line (blue lane marking) and that of an area other than the blue line. Hence, by using the brightness value A expressed by the expression (3), the blue line can be precisely detected.

What is claimed is:

1. A brightness value calculation apparatus, comprising:
a color image obtaining section which obtains a color image obtained by imaging a view outside a vehicle; and
a brightness value calculation section which calculates a brightness value A of a pixel of at least part of the color image based on an expression (1):
A=αA_{R}+βA_{G}+γA_{B} (1)
where A_{R} is brightness of R (red) of the pixel for which the brightness value A is to be calculated, A_{G} is brightness of G (green) of the pixel for which the brightness value A is to be calculated, A_{B} is brightness of B (blue) of the pixel for which a brightness value A is to be calculated, and α, β, γ are constants satisfying a relationship α>β>γ.

2. The brightness value calculation apparatus according to claim 1, wherein
the brightness value A is expressed by an expression (2):
A=A₀+pA_{R}−qA_{B} (2)
where A₀ is a brightness value of the pixel for which the brightness value A is to be calculated and which is subject to gray-scale processing, and p, q are positive constants.

3. The brightness value calculation apparatus according to claim 2, further comprising a yellow area determination section which determines whether or not an area of yellow in the color image is equal to or larger than a predetermined threshold value, wherein
the brightness value calculation section calculates the brightness value A based on the expression (2) if the area of yellow is equal to or larger than the threshold value, and determines the brightness value A to be the brightness value A₀ if the area of yellow is less than the threshold value.

4. A brightness value calculation apparatus, comprising:
a color image obtaining section which obtains a color image obtained by imaging a view outside a vehicle; and
a brightness value calculation section which calculates a brightness value A of a pixel of at least part of the color image based on an expression (3):
A=δA_{R}+εA_{G}+3A_{B} (3)
where A_{R} is brightness of R (red) of the pixel for which the brightness value A is to be calculated, A_{G} is brightness of G (green) of the pixel for which the brightness value A is to be calculated, A_{B} is brightness of B (blue) of the pixel for which a brightness value A is to be calculated, and δ, ε, 3 are constants satisfying a relationship δ<ε<3.

5. The brightness value calculation apparatus according to claim 4, wherein
the brightness value A is expressed by an expression (4):
A=A₀−pA_{R}+qA_{B} (4)
Where A₀ is a brightness value of the pixel for which the brightness value A is to be calculated and which is subject to gray-scale processing, and p, q are positive constants.

6. The brightness value calculation apparatus according to claim 5, further comprising a blue area determination section which determines whether or not an area of blue in the color image is equal to or larger than a predetermined threshold value, wherein
the brightness value calculation section calculates the brightness value A based on the expression (4) if the area of blue is equal to or larger than the threshold value, and determines the brightness value A to be the brightness value A₀ if the area of blue is less than the threshold value.

7. A lane marking detection system, comprising:
the brightness value calculation apparatus according to claim 1; and
a lane marking detection apparatus which detects a lane marking based on the brightness value.
